(19) United States
(12) Patent Application Publication
(10) Pub. No.: US 2026/0095947 A1
(43) Pub. Date: Apr. 2, 2026

(54) METHODS AND APPARATUS FOR SELECTING RANDOM ACCESS OCCASIONS IN SYSTEMS WHERE MULTIPLE TYPES OF RANDOM ACCESS OCCASIONS ARE CONFIGURED

(71) Applicant: INTERDIGITAL PATENT HOLDINGS, INC., Wilmington, DE (US)

(72) Inventors: Nazli KHAN BEIGI, Longueuil (CA); Jonghyun PARK, Syosset, NY (US); Moon IL LEE, Melville, NY (US); Paul MARINIER, Brossard (CA); Aata EL HAMSS, Laval (CA); Virgile GARCIA, Antibes (FR)

(73) Assignee: INTERDIGITAL PATENT HOLDINGS, INC., Wilmington, DE (US)

(21) Appl. No.: 18/902,044

(22) Filed: Sep. 30, 2024

(51) Int. Cl. H04W 74/0833; H04W 24/10

(52) U.S. Cl. CPC H04W 74/0833; H04W 24/10

(57) ABSTRACT

Methods and apparatus are described. A wireless transmit/receive unit (WTRU) includes a transceiver and a processor and is configured with multiple random access occasions (ROs), each being one or a first type of RO or a second type of RO. The processor and the transceiver select a synchronization signal block (SSB) from multiple SSBs for a random access preamble transmission. Each of the SSBs is mapped to a subset of the ROs. The processor and the transceiver identify a closest RO of the first type to a current frame and a closest RO of the second type to the current frame. The processor and the transceiver select either the closest RO of the first type or the closest RO of the second type based on one or more RO selection criteria and send the random access preamble in the selected RO.

### BACKGROUND

Time-division duplexing (TDD) is a duplexing scheme used in wireless networks in which uplink (UL) and downlink (DL) transmissions share the same frequency band but are separated in the time domain. Such networks, therefore, divide the time domain into frames, which are further split into time slots allocated for either uplink or downlink communication. The transmission direction alternates between UL and DL, with short guard periods in between to prevent interference and allow for smooth switching. This allows both uplink and downlink transmissions to occur on the same frequency but at different times.

### SUMMARY

Methods and apparatus are described. A wireless transmit/receive unit (WTRU) includes a transceiver and a processor and is configured with multiple random access occasions (ROs), each being one of a first type of RO or a second type of RO. The processor and the transceiver select a synchronization signal block (SSB) from multiple SSBs for a random access preamble transmission. Each of the SSBs is mapped to a subset of the ROs. The processor and the transceiver identify a closest RO of the first type to a current frame and a closest RO of the second type to the current frame. The processor and the transceiver select either the closest RO of the first type or the closest RO of the second type based on one or more RO selection criteria and send the random access preamble in the selected RO.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is a diagram of an example SBFD configuration in a TDD framework;

FIG. 3 is a diagram showing an example of RACH association periods for non-SBFD ROs;

FIG. 4 is a diagram showing an example of RACH association periods for SBFD ROs;

FIG. 5 is a flow diagram of an example method of selecting an RO in a system where different types of ROs are configured; and

FIG. 6 is a diagram showing an example of an SSB-to-RO mapping for N=4 configured, consecutive ROs.

### DETAILED DESCRIPTION

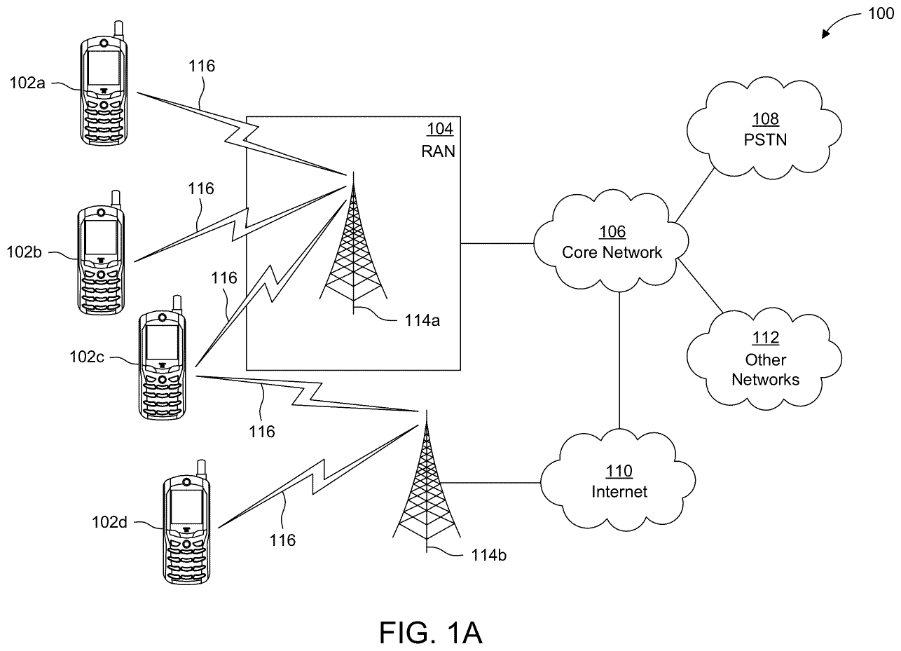

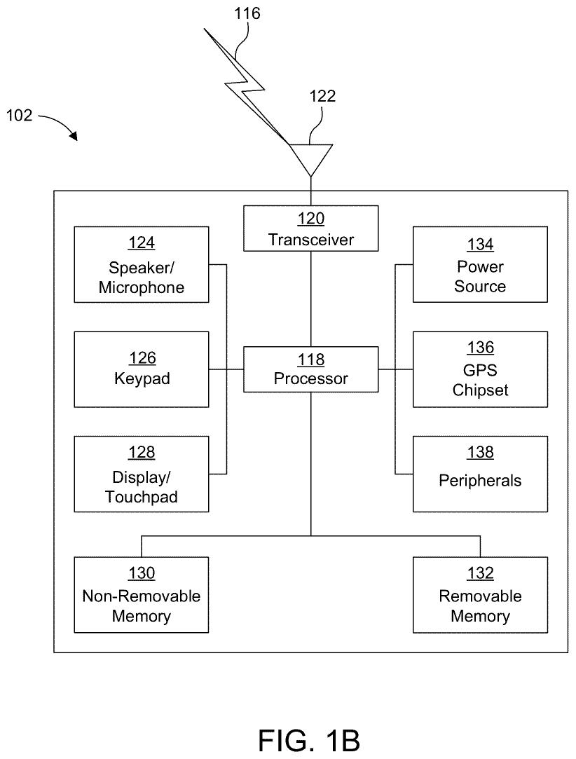

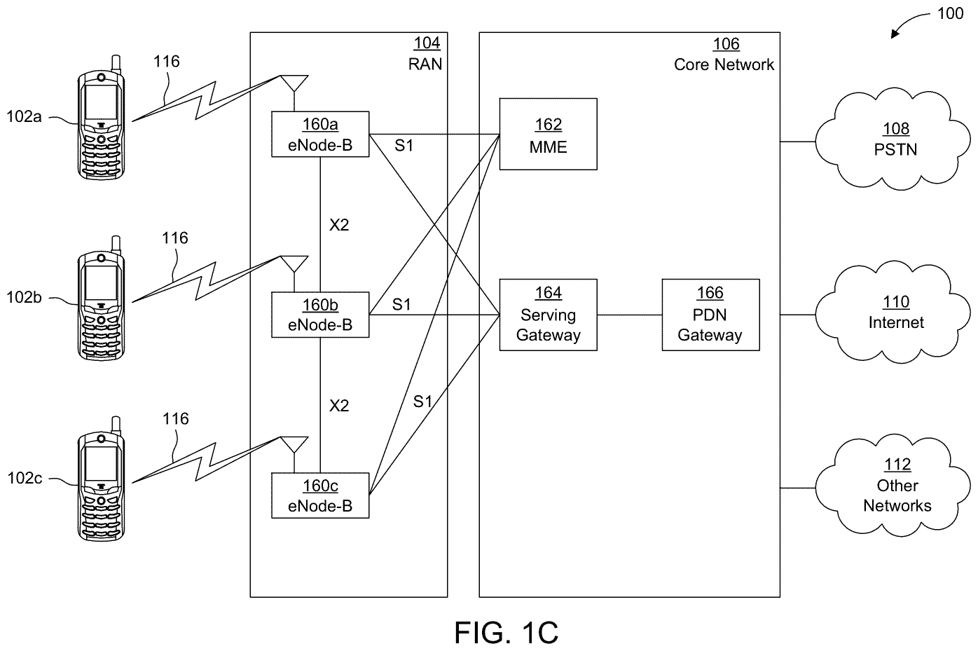

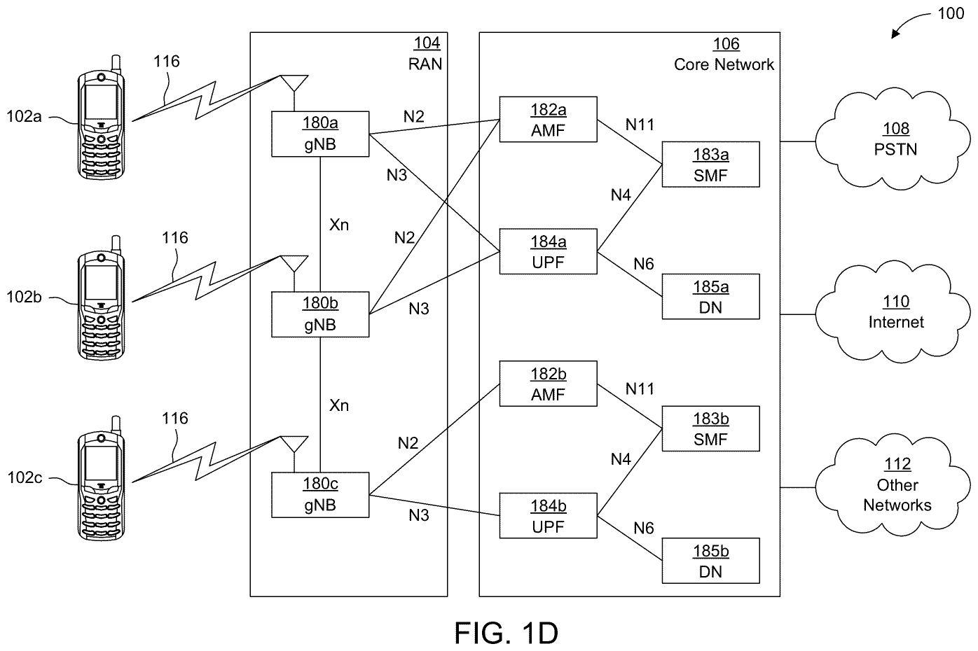

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

In Third Generation Partnership Project (3GPP) Release 18, sub-band full duplex (SBFD) was introduced as a way to improve uplink and downlink performance by allowing simultaneous transmissions within subbands on the same carrier, a departure from conventional TDD configurations. As part of the Release 19 work items, SBFD is recognized as a key component for enhancing full duplex capabilities, enhancing UL coverage, improving capacity, reducing latency, and so forth, and the feasibility of allowing full duplex, or, more specifically, SBFD, at the gNB within a conventional TDD band is being investigated.

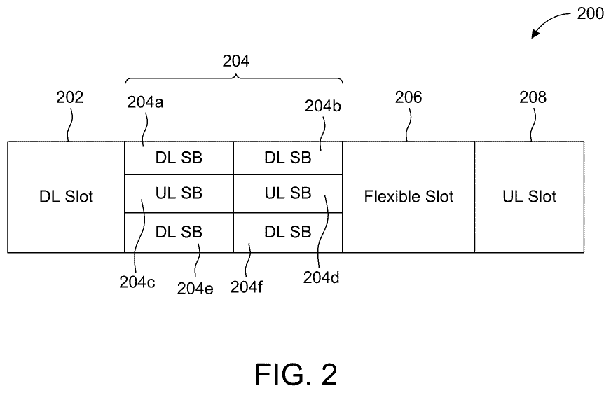

FIG. 2 is a diagram of an example SBFD configuration period 204 in a TDD frame 200. Like a legacy TDD frame, the TDD frame 200 includes dedicated DL and UL slots 202 and 208, respectively. The dedicated DL slot 202 may be a time slot that is fully allocated for DL communication. Similarly, the dedicated UL slot 208 may be a time slot that is fully allocated for UL communication. Additionally, the example TDD frame 200 includes a flexible slot 206, which can be dynamically allocated for either UL or DL transmission, such as depending on network requirements and/or traffic load. Unlike a legacy TDD frame, the example TDD frame 200 includes an SBFD configuration 204, which includes SBFD slots 204a, 204b, 204c, 204d, 204e, and 204f. In the illustrated example, the TDD frame 200 includes four DL SBFD slots 204a, 204b, 204c and 204d and two UL SBFD slots 204c and 204d.

In New Radio (NR), a WTRU may be configured with multiple random access channel (RACH) occasions (ROs) in the time and frequency domains. The ROs are mapped to synchronization signal blocks (SSBs) (also referred to as synchronization signal/physical broadcast channel (SS/PBCH) blocks (SSBs)) transmitted in one or more SSB bursts. In NR TDD, the ROs are only valid if they coincide with UL slots in the time domain, and the WTRU avoids PRACH transmission if the ROs are in DL slots.

A RACH association period, starting from frame 0, for mapping SSB indexes to ROs is the smallest integer number in the set determined by the PRACH configuration period according to TABLE 1, such that N SSB indexes are mapped at least once to the PRACH occasions within the association period. A WTRU may obtain the value for N (the total number of SSBs) from the value of ssb-PositionsInBurst in SIB1 or in ServingCellConfigCommon. If after an integer number of SSB to PRACH occasion mapping cycles within the association period there is a set of PRACH occasions or PRACH preambles that is not mapped to N SSB indexes, no SSB indexes may be mapped to the set of PRACH occasions or PRACH preambles. PRACH occasions not associated with SSB indexes after an integer number of association periods, if any, may not be used for PRACH transmission. The TDD cycle and slot configurations may be configured via tdd-UL-DL-ConfigurationCommon in TDD systems, where the number of UL/DL slots and symbols may be configured via parameters in TDD-UL-DL-ConfigCommon.

TABLE 1

| | Association period (number of |
|---|---|
| PRACH configuration period (msec) | PRACH configuration periods) |
| 10 | {1, 2, 4, 8, 16} |
| 20 | {1, 2, 4, 8} |
| 40 | {1, 2, 4} |
| 80 | {1, 2} |
| 160 | {1} |

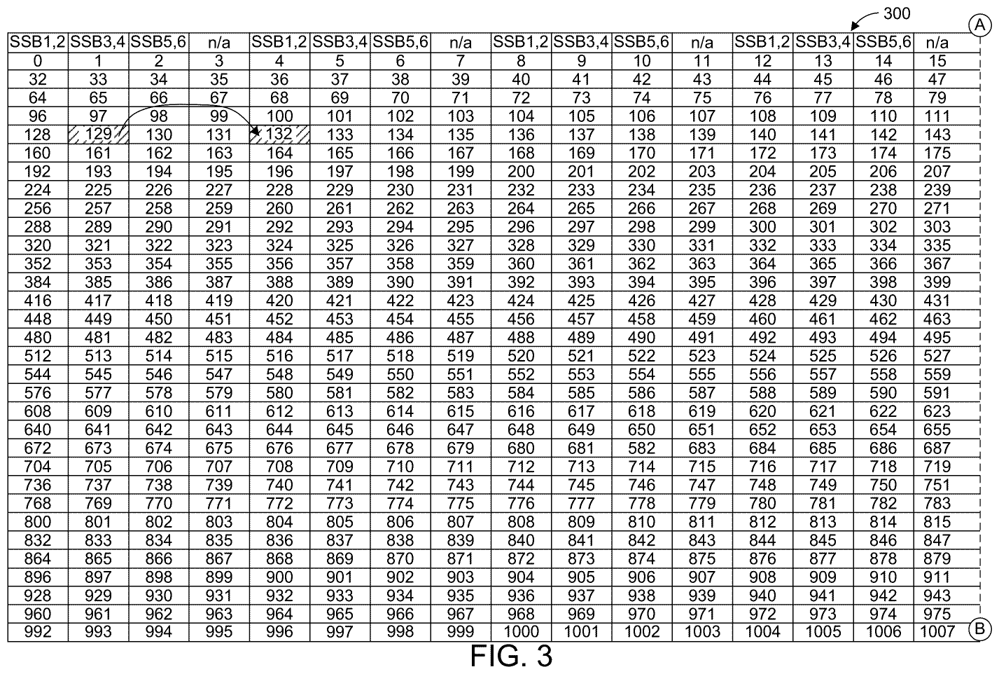

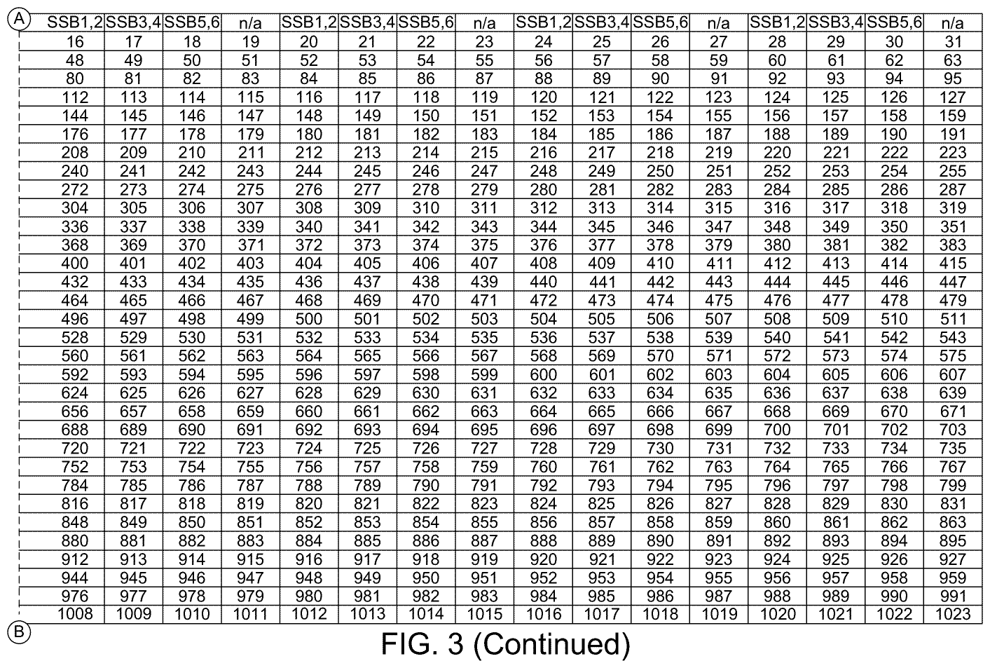

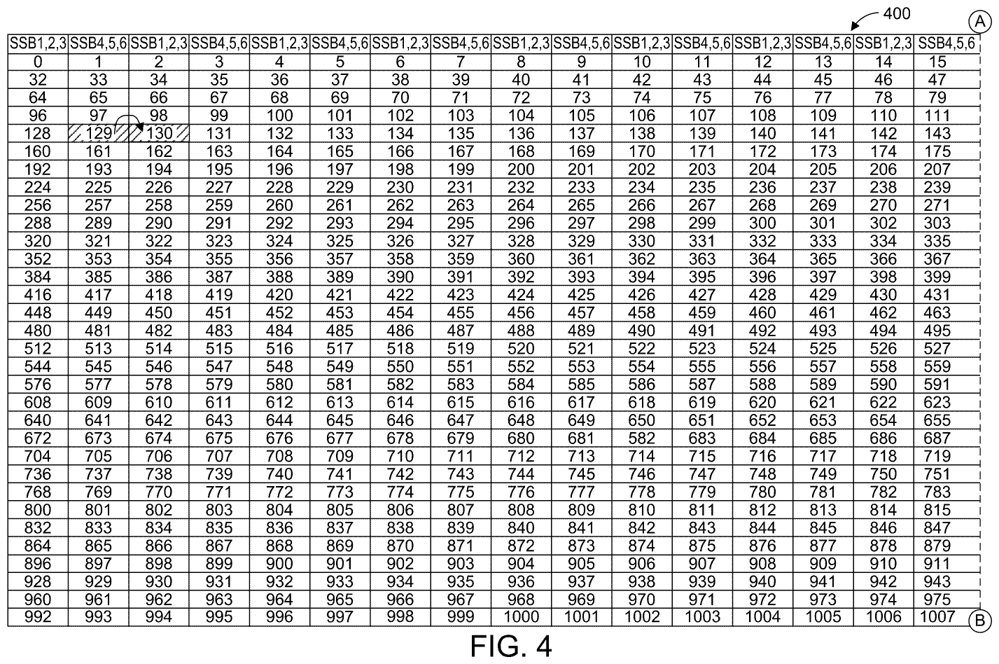

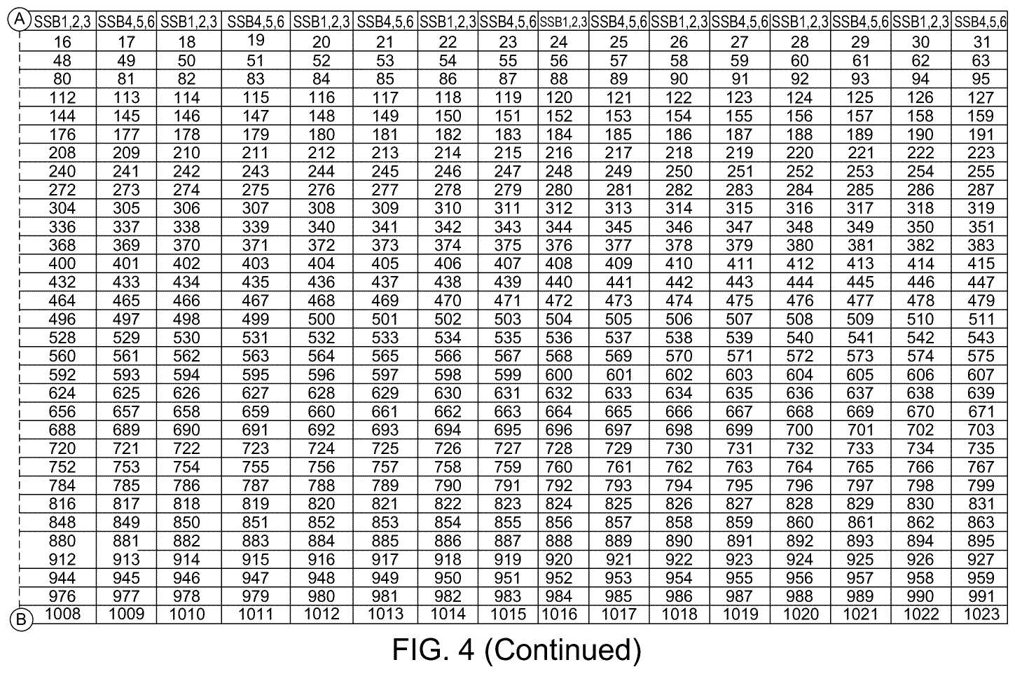

A number of non-SBFD ROs (also referred to herein as legacy ROs) and SBFD ROs within a TDD cycle may be different. Consequently, the association period may be different for legacy ROs and SBFD ROs. Consider, for example, a system with 6 SSBs, and a PRACH configuration period of 10 msec. In this example, the TDD cycle includes 16 slots, configured as: {DDDDDDDDDDDDDSUU}, and a single RACH configuration is used for both legacy and SBFD ROs. Assume also for this example that RACH config=71 in FR2 (e.g., SCS 120 kHz) with preamble format A3 and no frequency divisional multiplexing (FDM) ROs are used. As such, slots #7, #11, and #15 are RACH slots with 2 ROs in each RACH slot. Based on this configuration, each frame incudes 2 legacy ROs and 4 SBFD ROs, resulting in an association period of 4 for legacy ROs and 2 for SBFD ROs. FIG. 3 is a diagram 300 showing an example of RACH association periods for non-SBFD ROs. FIG. 4 is a diagram 400 showing an example of RACH association periods for SBFD ROs.

As can be seen in FIG. 3, for example, a WTRU that is in frame 129 that wants to send a RACH preamble associated with SSB1 must wait until frame 132 to send the RACH preamble on non-SBFD ROs, which is a wait of at least 40 ms. However, as can be seen in FIG. 4, the WTRU that is in frame 129 can send the RACH preamble on SBFD ROs in frame 130 and need only wait at most 10 ms.

If the association period for SBFD ROs is shorter than the association period for non-SBFD ROs, such as is the case in the above example, the WTRUs would always select the non-legacy ROs with the shorter association period due to the corresponding RO being nearest in time. Such difference in association periods between legacy and SBFD ROs may result in higher load, traffic, and collision probability in the ROs with shorter association periods, degrading the expected performance. Moreover, if SBFD ROs have shorter association periods and if most WTRUs in the cell are SBFD-capable, the non-SBFD/legacy ROs may be left unused, resulting in a waste of resources. On the other hand, WTRUs with low coverage that need higher UL power and power ramping for sending RACH preambles may prefer to use legacy ROs due, for example, to higher power limits (e.g., Pcmax) compared to SBFD ROs, since RACH transmission in SBFD ROs may cause potential WTRU-to-WTRU cross-link interference (CLI). Such cases may result in overloading the legacy ROs and increasing collision in legacy ROs, particularly for legacy WTRUs.

Embodiments described herein, therefore, provide for devices and methods that enable RO selection for random access transmission based on criteria other than transmission time, such as based on WTRU coverage, latency, priority and/or random selection. In some embodiments, network control of RO selection is enabled, which may give the network flexibility to affect the WTRU's RO selection to prevent overloading of ROs of a certain RO type based on network load, traffic, latency, coverage, etc.

Hereinafter, ‘a’ and ‘an’ and similar phrases are to be interpreted as ‘one or more’ and ‘at least one’. Similarly, any term which ends with the suffix ‘(s)’ is to be interpreted as ‘one or more’ and ‘at least one’. The term ‘may’ is to be interpreted as ‘may, for example’. A symbol ‘/’ (e.g., forward slash) may be used herein to represent ‘and/or’, where for example, ‘A/B’ may imply ‘A and/or B’.

A WTRU may transmit or receive a physical channel or reference signal according to at least one spatial domain filter. The term “beam” may be used to refer to a spatial domain filter. A WTRU may transmit a physical channel or signal using the same spatial domain filter as the spatial domain filter used for receiving an RS (such as CSI-RS) or an SS block. The WTRU transmission may be referred to as “target”, and the received RS or SS block may be referred to as “reference” or “source”. In such case, the WTRU may be said to transmit the target physical channel or signal according to a spatial relation with a reference to such RS or SS block.

The WTRU may transmit a first physical channel or signal according to the same spatial domain filter as the spatial domain filter used for transmitting a second physical channel or signal. The first and second transmissions may be referred to as “target” and “reference” (or “source”), respectively. In such case, the WTRU may be said to transmit the first (target) physical channel or signal according to a spatial relation with a reference to the second (reference) physical channel or signal.

A spatial relation may be implicit, configured by RRC or signaled by MAC CE or DCI. For example, a WTRU may implicitly transmit PUSCH and DM-RS of PUSCH according to the same spatial domain filter as an SRS indicated by an SRI indicated in DCI or configured by RRC. In another example, a spatial relation may be configured by RRC for an SRS resource indicator (SRI) or signaled by MAC CE for a PUCCH. Such spatial relation may also be referred to as a “beam indication”.

The WTRU may receive a first (target) downlink channel or signal according to the same spatial domain filter or spatial reception parameter as a second (reference) downlink channel or signal. For example, such association may exist between a physical channel such as PDCCH or PDSCH and its respective DM-RS. At least when the first and second signals are reference signals, such association may exist when the WTRU is configured with a quasi-colocation (QCL) assumption type D between corresponding antenna ports. Such association may be configured as a transmission configuration indicator (TCI) state. A WTRU may be indicated with an association between a CSI-RS or SS block and a DM-RS by an index to a set of TCI states configured by RRC and/or signaled by MAC CE. Such indication may also be referred to as a “beam indication”.

Hereafter, a transmission and reception point (TRP) may be interchangeably used with one or more of transmission point (TP), reception point (RP), radio remote head (RRH), distributed antenna (DA), base station (BS), a sector (of a BS), and a cell (e.g., a geographical cell area served by a BS), but still consistent with the embodiments described herein. Hereafter, multi-TRP may be interchangeably used with one or more of MTRP, M-TRP, and multiple TRPs, but still consistent with the embodiments described herein.

Hereinafter, the term “subband” and/or “sub-band” is used to refer to a frequency-domain resource and may be characterized by at least one of a set of resource blocks (RBs), a set of resource block sets (RB sets) (e.g. when a carrier has intra-cell guard bands), a set of interlaced resource blocks, a bandwidth part (or portion thereof) and/or a carrier (or portion thereof). For example, a subband may be characterized by a starting RB and number of RBs for a set of contiguous RBs within a bandwidth part. A subband may also be defined by the value of a frequency-domain resource allocation field and bandwidth part index.

Hereinafter, the term “XDD” is used to refer to a subband-wise duplex (e.g., either UL or DL being used per subband) and may be characterized by at least one of cross division duplex (e.g., subband-wise FDD within a TDD band), subband non-overlapping full duplex (SBFD), subband-based full duplex (e.g., full duplex as both UL and DL are used/mixed on a symbol/slot, but either UL or DL being used per subband on the symbol/slot), frequency-domain multiplexing (FDM) of DL/UL transmissions within a TDD spectrum, a full duplex other than a same-frequency (e.g., spectrum sharing, subband-wise-overlapped) full duplex, and/or an advanced duplex method (e.g., other than (pure) TDD or FDD.

Hereinafter, the term “dynamic(/flexible) TDD” is used to refer to a TDD system/cell that may dynamically (and/or flexibly) change/adjust/switch a communication direction (e.g., a downlink, an uplink, or a sidelink, etc.) on a time instance (e.g., slot, symbol, subframe, and/or the like). In an example, in a system employing dynamic/flexible TDD, a component carrier (CC) or a bandwidth part (BWP) may have one single type among ‘D’, ‘U’, and ‘F’ on a symbol/slot based on an indication by a group-common (GC)-DCI (e.g., format 2_0) including a slot format indicator (SFI), and/or based on tdd-UL-DL-config-common/dedicated configurations. On a given time instance/slot/symbol, a first gNB (e.g., cell, TRP) employing dynamic/flexible TDD may transmit a downlink signal to a first WTRU being communicated/associated with the first gNB based on a first SFI and/or tdd-UL-DL-config configured/indicated by the first gNB, and a second gNB (e.g., cell, TRP) employing dynamic/flexible TDD may receive an uplink signal transmitted from a second WTRU being communicated/associated with the second gNB based on a second SFI and/or tdd-UL-DL-config configured/indicated by the second gNB. In an example, the first WTRU may determine that the reception of the downlink signal is being interfered with by the uplink signal, where the interference caused by the uplink signal may refer to WTRU-to-WTRU CLI. Herein, the term CLI may be used interchangeably with interference, and still consistent with the embodiments described herein.

Hereafter, downlink reception may be used interchangeably with Rx occasion, PDCCH, PDSCH, and/or SSB reception, but still consistent with the embodiments described herein. Hereafter, uplink transmission may be used interchangeably with Tx occasion, PUCCH, PUSCH, PRACH, and/or SRS transmission, but still consistent with the embodiments described herein.

Herein, time instance, slot, symbol, and subframe may be used interchangeably, but still consistent with the embodiments described herein.

Herein, UL-only and DL-only Tx/Rx occasions may be used interchangeably with legacy TDD UL or legacy TDD DL, respectively, and still consistent with the embodiments described herein. In an example, the legacy TDD UL transmission or legacy DL reception occasions are the cases where SBFD is not configured and/or where SBFD is disabled.

Hereinafter, the terms received signal power, received signal energy, received signal strength, SSB EPRE, CSI EPRE, RSRP, RSSI, SINR, RSRQ, SS-RSRP, SS-RSSI, SS-SINR, SS-RSRQ, CSI-RSRP, CSI-RSSI, CSI-SINR, and CSI-RSRQ may be used interchangeably, but still consistent with the embodiments described herein.

Herein, the term non-SBFD may be used interchangeably with operation without SBFD, TDD, legacy TDD, and still consistent with the embodiments described herein. Further, while the embodiments are described herein relative to SBFD type ROs and non-SBFD or legacy type ROs, they may be referred to generically at a first type of RO and a second type of RO as the embodiments described herein may be applicable in any system where different types of ROs are configured or otherwise available for use by a WTRU.

Herein, the terms ‘paired spectrum’ and FDD may be used interchangeably, but still consistent with the embodiments described herein. Herein, the terms ‘unpaired spectrum’ and TDD may be used interchangeably, but still consistent with the embodiments described herein.

Herein, the terms ‘WTRU is configured’, ‘WTRU is indicated’, ‘WTRU receives configuration’, and so forth, may imply that the configuration is indicated, for example, ‘via RRC, MAC-CE, DCI, MIB, SIB, and so forth’, unless indicated otherwise, where for example, ‘WTRU is configured’ may imply ‘WTRU is configured via RRC, MAC-CE, MIB, SIB, and so forth’.

Herein, the terms PRACH, RACH, random access, random access occasion, RACH occasion, PRACH transmission, RACH transmission, RA, and RO, may be used interchangeably, and still consistent with the embodiments described herein.

Herein, the term reference signal, RS, SSB, CSI-RS, PRS, LP-SS, DM-RS, may be used interchangeably with interference, and still consistent with the embodiments described herein.

Herein, the terms SBFD ROs and additional ROs may be used interchangeably with interference, and still consistent with the embodiments described herein. Herein, the terms non-SBFD ROs and legacy ROs may be used interchangeably with interference, and still consistent with the embodiments described herein.

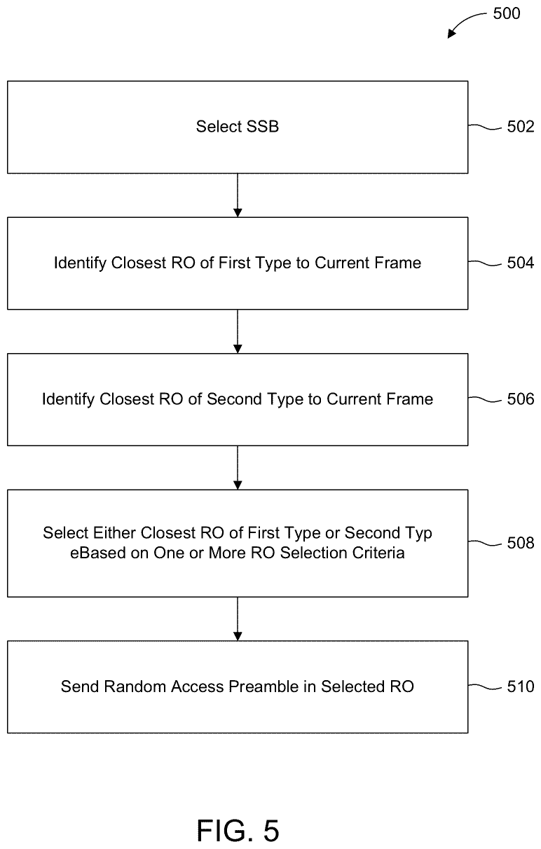

FIG. 5 is a flow diagram 500 of an example method of selecting an RO in a system where different types of ROs are configured. In the example illustrated in FIG. 5, which is implemented in a WTRU, the WTRU is configured with multiple ROs, each of which is one of an RO of a first type or an RO of a second type. In some embodiments, the first type of RO is an SBFD RO and the second type of RO is a non-SBFD RO.

A WTRU may receive configurations (e.g., from a gNB, a node, or a device) for full-duplex (FD) operation conducted by at least one device in a network. In an example, the FD operation may be conducted by a gNB (e.g., a BS, a node, a TRP, or a cell). The WTRU may operate in a half-duplex (HD) mode for communicating with the gNB, where the HD mode may imply at a given time the WTRU either performs a UL transmission or a DL reception (e.g., not both UL and DL simultaneously at the given time). The WTRU may also operate in an FD mode for communicating with the gNB, for example if a corresponding WTRU capability is reported to the gNB and/or the WTRU receives a confirmation signal (e.g., enabling the FD and/or configuring the FD mode) in response to the WTRU transmitting WTRU capability signaling.

The FD operation may imply that, at a given time, a transmitter (e.g., the gNB and/or the WTRU) may simultaneously transmit a first signal and receive a second signal. The FD operation may include a subband overlapping FD (e.g., in-band FD (IBFD)) operation where a first frequency-domain resource (e.g., one or more RBGs, RBs, and/or REs) allocated for the first signal may have a full (or at least a partial) overlap with a second frequency-domain resource allocated for the second signal. The FD operation may include an SBFD operation where a first frequency-domain resource allocated for the first signal (e.g., assigned within a configured SBFD subband, such as a DL subband and/or usable DL PRBs) does not have an overlap with a second frequency-domain resource allocated for the second signal (e.g., assigned within a configured SBFD subband, such as a UL subband and/or usable UL PRBs). Hereafter, for brevity of discussion, the FD operation may include the SBFD operation. However, the embodiments described herein may be applicable to other FD operation types (e.g., IBFD, etc.).

A WTRU may be configured with one or more types of slots within a bandwidth. A first type of slot may be used or determined for a first direction (e.g., downlink), a second type of slot may be used or determined for a second direction (e.g., uplink), and a third type of slot may have a first group of frequency resources within the bandwidth for a first direction and a second group of frequency resources within the bandwidth for a second direction. Herein, bandwidth may be interchangeably used with bandwidth part (BWP), carrier, subband, and system bandwidth, The first type of slot (e.g., the slot for a first direction) may be a downlink slot. The second type of slot (e.g., slot for a second direction) may be an uplink slot. The third type of slot may be an SBFD slot. A group of frequency resources for a first direction may be or include a downlink subband, a downlink frequency resource, or downlink RBs. A group of frequency resources for a second direction may be or include an uplink subband, uplink frequency resource, or uplink RBs. A group of frequency resources for a flexible direction (e.g., that can be configured for a first direction, second direction, etc.) may be or include a flexible subband, flexible frequency resource, or flexible RBs. A group of frequency resources between a first direction and a second direction may be a guard band, guard frequency resource, or guard RBs.

In an example, an SBFD-enabled WTRU may receive or be configured with one or more SBFD UL or DL subbands in one or more DL, UL, and/or flexible TDD time instances (e.g., symbols, slots, frames, and so forth). The WTRU may be configured with one or more resource allocations for SBFD subbands. For example, an SBFD configuration may include a flag signal (e.g., enabled/disabled), where, for example, a first value (e.g., zero (0) may indicate a first mode of operation (e.g., an SBFD configuration), and a second value (e.g., one (1)) may indicate a second mode of operation (e.g., a non-SBFD operation). The modes of operation (e.g., SBFD or non-SBFD) may be indicated via, for example, MIB, SIB, RRC, MAC-CE, DCI, and so forth.

A WTRU may receive time resources (e.g., one or more symbols, slots, and so forth) for which the first mode of operation (e.g., SBFD) is defined in, for example, one or more BWPs, subbands, component carriers (CCs), cells, and so forth. The WTRU may receive the frequency resources (e.g., subbands, BWPs, etc. including one or more PRBs) within active and/or linked BWP, for which the first mode of operation (e.g., SBFD) is configured. The time instances (e.g., slots, symbols) may be indicated based on periodic, semi-persistent, or aperiodic configurations. For example, the time instances may be indicated via a bitmap configuration, where each bit may correspond to a time instance (e.g., slot, symbol, subframe, etc.) and each bit indication may indicate whether a corresponding time instance can be used for the first or second mode of operation.

For example, a WTRU may be configured with a DL TDD configuration for a CC or a BWP for one or more Rx occasions (e.g., via tdd-UL-DL-config-common, dedicated configurations, slot format indicator (SFI), and so forth). As such, if the first mode of operation (e.g., SBFD) is configured, one or more of the configured frequency resources (e.g., subbands, PRBs, and/or BWPs) may be configured for the transmission in UL channels and/or Tx occasions.

For another example, a WTRU may be configured with a UL TDD configuration for a CC or a BWP for one or more Tx occasions (e.g., via tdd-UL-DL-config-common, dedicated configurations, slot format indicator (SFI), and so forth). As such, if the first mode of operation (e.g., SBFD) is configured, one or more of the configured frequency resources (e.g., subbands, PRBs, and/or BWPs) may be configured as the DL channels and/or Rx occasions.

For another example, the WTRU may be configured with a DL, UL, or flexible TDD configuration for a CC or a BWP for one or more Rx/Tx occasions (e.g., via tdd-UL-DL-config-common, dedicated configurations, slot format indicator (SFI), and so forth). As such, if the first mode of operation (e.g., SBFD) is configured, one or more of the configured frequency resources (e.g., subbands, PRBs, and/or BWPs) may be configured for the first mode of operation (e.g., either UL transmission or DL reception based on the configurations).

The duplexing mode for the first mode of operation (e.g., SBFD configuration (UL/DL)) may be indicated via a flag indication, where, for example, a first value (e.g., zero (0) may indicate a first direction (e.g., UL duplexing mode) and a second the value (e.g., one (1) may indicate a second direction (e.g., DL duplexing model). The duplexing mode configuration and/or flag for the first mode of operation (e.g., SBFD) may be configured as part of the modes of operation configuration, for example via MIB, SIB, RRC, DCI, MAC-CE, etc. The duplexing mode configuration and/or flag for the first mode of operation (e.g., SBFD) may be configured as part of the resource allocation configuration for a Tx/Rx occasion.

For example, a WTRU may be configured with one or more types of slots. The WTRU may be configured with a first slot of a first type, where the first type may be, for example, an SBFD slot. The WTRU may be configured with a second slot of a second type, where the second type may be, for example, a non-SBFD slot. As for the first slot of the first type (e.g., SBFD), the WTRU may be configured with one or more DL, UL, flexible, guard, etc. subbands in the frequency domain, throughout the BWP, for the duration of the first slot. However, in the second slot of the second type (e.g., non-SBFD), the WTRU may be configured with only one direction type, for example DL, UL, flexible, etc., in the frequency domain, throughout the BWP, for the duration of the second slot.

For example, if a WTRU is configured with a second slot with the UL direction, this may imply a legacy TDD UL slot, UL-only slot, and/or non-SBFD UL slot. In another example, if the WTRU is configured with a third slot of the second type (e.g., non-SBFD) with the DL direction, this may imply a legacy TDD DL slot, DL-only slot, and/or non-SBFD DL slot. In another example, if the WTRU is configured with a fourth slot of a second type (non-SBFD) with a flexible direction, this may imply a legacy TDD flexible slot and/or non-SBFD flexible slot, and so forth.

A WTRU may receive, identify, or be configured with the time domain resource allocations for one or more ROs based on the higher-layer parameter prach-ConfigurationIndex, or by msgA-PRACH-ConfigurationIndex, if configured. The ROs may be consecutive ROs. These parameters may denote the PRACH configuration index corresponding to one or more tables that include random access parameters.

The WTRU may be configured with one or more of a preamble format parameter, a frame number, subframe number, and/or slot number parameter, a starting symbol parameter, a number of PRACH slots within a 60 kHz slot parameter, a number of time domain PRACH occasions within a PRACH slot (Nₜ^{RA,slot}) parameter, and/or a PRACH duration parameter.

Regarding the preamble format parameter, a WTRU may be configured with a preamble format, which may be one of multiple possible formats, including, for example, A1, A2, A3, B1, A1/B1, A2/B2, A3/B3, B4, C0, and/or C2. The preamble format may identify the corresponding Cyclic Prefix (CP) duration, sequence part duration, guard time duration (if applicable), etc.

Regarding the frame number, subframe number and/or slot number parameter, a WTRU may be configured with time-domain allocations, subframe numbers, and/or slot numbers during which the ROs may be configured. Using this parameter, the WTRU may determine the RO slot, for example within the corresponding subframe, where the WTRU may transmit the configured PRACH in one or more of the determined ROs.

Regarding the starting symbol parameter, a WTRU may determine the symbol-level index corresponding to the starting position of the first RO transmission within the indicated and/or configured RO slot.

Regarding the number of PRACH slots within a 60 KHz slot parameter, for example, a WTRU may be indicated with the number of PRACH slots within a reference 60 kHz slot. For example, a WTRU may be configured with the number of PRACH slots for high SCS values, such as 120 kHz, 480 kHz, 960 kHz, etc., where the WTRU may consider the 60 KHz PRACH slot as the reference slot.

Regarding the number of time-domain PRACH occasions within a PRACH slot (Nₜ^{RA,slot}) parameter, for example, the WTRU may be configured with the number of consecutive ROs that are located within a PRACH slot in the time domain.

Regarding the PRACH duration parameter, a WTRU may be configured with the duration of an RO in number of symbols.

A WTRU may receive the frequency domain resource allocations for the ROs based on one or more of the following higher-layer parameters: a msg1-FrequencyStart parameter or a msgA-RO-FrequencyStart parameter and/or an msg1-FDM parameter or an msgA-RO-FDM parameter. If the msg1-FrequencyStart parameter or the msgA-RO-FrequencyStart parameter is configured, it may indicate the offset of the lowest PRACH transmission occasion in the frequency domain with respect to the PRB 0. If the msg1-FDM parameter or the msgA-RO-FDM parameter is configured, it may indicate the number of PRACH transmission occasions that are FDM'd in one time-domain RO. The WTRU may receive, identify, or be configured with the number of ROs in the frequency domain (M) per each time-domain PRACH occasion based on the higher layer parameter msg1-FDM, msg1-FDM-16, or msgA-RO-FDM, if configured, where msg1-FDM={one, two, four, eight}. The WTRU may number the PRACH frequency resources n_{RA}={0,1, . . . ,M−1}, starting from the lowest frequency, in increasing order in the initial uplink BWP during the initial access or the active uplink BWP otherwise.

A WTRU may receive the association and mapping between the SSB indexes and PRACH transmission occasions based on the higher layer parameter ssb-perRACH-OccasionAndCB-PreamblesPerSSB={⅛,¼,½,1,2,4,8,16}. This parameter may indicate the number of SSB indexes associated with a PRACH transmission occasion in addition to the number of preambles per SSB index per PRACH occasion.

In a random access procedure, a WTRU may be provided with a number of SSB indexes associated with one RACH occasion by ssb-perRACH-OccasionAndCB-PreamblesPerSSB, within an SSB-RO mapping cycle. An example of an RRC configuration for ssb-perRACH-OccasionAndCB-PreamblesPerSSB may be:

| RACH-ConfigCommon : := | SEQUENCE { | |
|---|---|---|
| RACH-ConfigGeneric | RACH-ConfigGeneric, | OPTIONAL, --Need S |

| | |
|---|---|
| totalNumberOfRA-Preambles | INTEGER (1..63) |
| ssb-perRACH-OccasionAndCB-PreamblesPerSSB | CHOICE { |
| oneEighth | ENUMERATED {n4,n8,n12,n16,n20,n24,n28,n32,n36,n40,n44,n48,n52,n56,n60,n64}, |
| oneFourth | ENUMERATED {n4,n8,n12,n16,n20,n24,n28,n32,n36,n40,n44,n48,n52,n56,n60,n64}, |
| oneHalf | ENUMERATED {n4,n8,n12,n16,n20,n24,n28,n32,n36,n40,n44,n48,n52,n56,n60,n64}, |
| one | ENUMERATED {n4,n8,n12,n16,n20,n24,n28,n32,n36,n40,n44,n48,n52,n56,n60,n64}, |
| two | ENUMERATED {n4,n8,n12,n16,n20,n24,n28,n32}, |
| four | INTEGER (1..16), |
| eight | INTEGER (1..8), |
| sixteen | INTEGER (1..4) |

OPTIONAL, --Need M

}

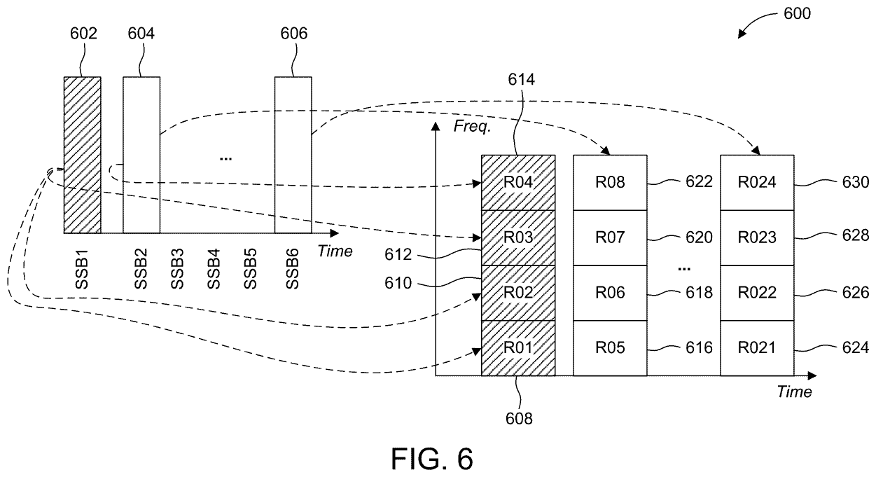

FIG. 6 is a diagram showing an example of an SSB-to-RO mapping 600 for N=4 configured, consecutive ROs. In the example illustrated in FIG. 6, each SSB index is mapped to N=4 configured consecutive ROs, ssb-perRACH-OccasionAndCB-PreamblesPerSSB=¼, Total number of SSBs=6, and Msg1-FDM=4. A first SSB 602 is mapped to the first four consecutive ROs 608, 610, 612 and 614. A second SSB 604 is mapped to the second four consecutive ROs 616, 618, 620 and 622. Each additional SSB (e.g., third, fourth, fifth and sixth SSBs) may be mapped in a similar manner, with the third SSB (not labeled) being mapped to the third four consecutive ROs, the fourth SSB (not labeled) being mapped to the fourth four consecutive ROs, the fifth SBB (not labeled) being mapped to the fifth four consecutive ROs, and the sixth SSB 606 being mapped to the sixth four consecutive ROs 624, 626, 628 and 630. As such, a WTRU may select one RO randomly out of the N configured ROs to transmit the PRACH preamble.

A RACH association period, starting from frame 0, for mapping SSB indexes to ROs is the smallest integer number in the set determined by the PRACH configuration period according to TABLE 1, such that N SSB indexes are mapped at least once to the PRACH occasions within the association period, where a WTRU may obtain N, the total number of SSBs, from the value of ssb-PositionsinBurst in SIB1 or in ServingCellConfigCommon. If after an integer number of SSB indexes to PRACH occasions mapping cycles within the association period there is a set of PRACH occasions or PRACH preambles that are not mapped to N SSB indexes, no SSB indexes may be mapped to the set of PRACH occasions or PRACH preambles. An association pattern period may include one or more association periods and may be determined so that a pattern between PRACH occasions and SSB indexes may repeat at most every 160 msec. PRACH occasions not associated with SSB indexes after an integer number of association periods, if any, may not be used for PRACH transmissions.

PRACH power (e.g., for a PRACH preamble transmission) may be determined by a WTRU. The WTRU may determine the PRACH power based on one or more of a preamble received target power (e.g., PREAMBLE_RECEIVED_TARGET_POWER) and a determined, measured, or calculated pathloss. The WTRU may limit the power by a maximum power (e.g., Pcmax,c which may also be represented by Pcmax,f,c.) For example, a WTRU may determine a transmission power for a PRACH, P_{PRACH,b,f,c}(i), on active UL BWP b of carrier f of cell c based on DL RS for cell c in transmission occasion i as

$${P}_{PRACH , b , f , c} ( i ) = min \{ {P}_{CMAX , f , c} ( i ) , {P}_{PRACH , target , f , c} + P {L}_{b , f , c} \} [ dBm ] ,$$

where P_{CMAX,f,c}(i) may be a WTRU configured maximum output power for carrier f of cell c within transmission occasion i, P_{PRACH,target,f,c} may be the PRACH target reception power PREAMBLE_RECEIVED_TARGET_POWER for the active UL BWP b of carrier f of cell c, and PL_{b,f,c} may be a pathloss for the active UL BWP b of carrier f based on the DL RS associated with the PRACH transmission on the active DL BWP of cell c and may be calculated by the WTRU in dB as referenceSignalPower—higher layer filtered RSRP in dBm. The DL RS may be an SSB or a CSI-RS.

The WTRU may determine PREAMBLE_RECEIVED_TARGET_POWER based on a power ramping counter and a power ramping step. For example, PREAMBLE_RECEIVED_TARGET_POWER may be determined as preambleReceivedTargetPower+DELTA_PREAMBLE+(PREAMBLE_POWER_RAMPING_COUNTER−1)×PREAMBLE_POWER_RAMPING_STEP+POWER_OFFSET_2STEP_RA. One or more of preambleReceivedTargetPower, DELTA_PREAMBLE, PREAMBLE_POWER_RAMPING_STEP, and POWER_OFFSET_2STEP_RA may be configured (e.g., received via signalling such as SIB or RRC signalling). POWER_OFFSET_2STEP_RA may be omitted or set to 0, for example when a 4-step RA procedure is used.

The WTRU may determine the maximum output power it may use for a transmission based on one or more of the WTRU's power class maximum power, power reductions allowed for meeting requirements, such as emissions or specific absorption rate (SAR) requirements, reductions related to tolerances, and a signalled maximum power, Pcmax,c.

A WTRU may monitor, receive, detect, and/or select an SSB in an SSB burst. In an example, a WTRU may select the SSB during the initial access procedure or as part of a beam failure detection (BFR) procedure. For example, the WTRU may measure the received power (e.g., RSRP) based on the received SSBs and select an SSB based on the measured received power (e.g., with highest RSRP). The WTRU may use the selected SSB for connecting to a cell and/or for PRACH preamble transmission to the cell. The WTRU may receive a physical broadcast channel (PBCH). The PBCH may carry system information. The PBCH may include or carry a master information block (MIB). The term MIB may be used to represent the content, information, payload, and/or bits carried by the PBCH. PBCH and MIB may be used interchangeably herein. The PBCH may be part of an SSB. The SSB may have an SSB index. A Node-B, cell, TRP, etc. may transmit one or more SSBs where each SSB may have an SSB index.

A WTRU may use one or more configuration information received as part of PBCH, MIB, and/or SSB to determine the resources to monitor, receive and/or detect Control Resource Set Zero (CORESET0) for receiving the Type0-PDCCH Common Search Space (CSS). The Type0-PDCCH CSS may include indications to one or more system information block (SIB), for example SIB1.

In an example, a WTRU may receive, be configured with, and/or indicated with one or more parameters indicating the transmitted SSBs in an SSB burst. For example, the WTRU may receive an indication (e.g., via SIB1 and/or RRC), for example ssb-PositionsinBurst, that may include a bitmap to indicate the transmitted SSBs within the SSB burst.

A WTRU may be configured with one or more RO types. For example, the WTRU may be configured with a Type 1 RO. For example, the Type 1 ROs may coincide with one or more TDD UL-only time instances. In another example, the WTRU may be configured with a Type 2 RO. For example, the type 2 ROs may coincide with one or more SBFD and/or supplementary time instances. In an example, the Type 1 ROs may be indicated as non-SBFD ROs, legacy ROs, etc. In another example, the type 2 ROs may be indicated as SBFD ROs, additional ROs, etc.

A WTRU may be configured with PRACH transmission based on one or more of the configured RO types. For example, the random access resources corresponding to different RO types may be mutually exclusive

For example, a WTRU may receive a first set of configuration information for a random-access procedure for the Type 1 ROs and a second set of configuration information for a random-access procedure for the Type 2 ROs. In another example, the WTRU may receive a first set of configurations for a random access procedure for the Type 1 ROs, and the WTRU may determine, be configured, and/or indicated to use the received first set of configurations for Type 2 ROs as well. As such, in an example, in case a first RO coincides with a non-SBFD (e.g., UL-only TDD) symbol, the WTRU may consider the first RO as a non-SBFD (e.g., legacy) RO. In another example, in case a second RO coincides with an SBFD symbol, the WTRU may consider the second RO as an SBFD (e.g., additional) RO.

The WTRU may receive the configuration information via SIB, RRC, MAC-CE, DCI, etc. In an example, the WTRU may receive the indications as part of the SIB during initial access. In another example, the WTRU may receive the indications via RRC for a BFR procedure. In another example, the WTRU may receive the indications via MAC-CE as part of a PDCCH order.

The RACH configurations may include information about time and frequency resources where the ROs may be scheduled. For example, the RACH configurations may include indications of the number of ROs that may be mapped in the frequency domain per each configured RO time instance. That is, the WTRU may receive configurations of the number of ROs that are FDM'd in one RO time instance (e.g., via msg1-FDM).

Referring back to FIG. 5, a WTRU may select an SSB (502). The SSB may be selected from multiple SSBs for a random access preamble transmission. Each of the multiple SSBs may be mapped to a subset of the multiple ROs.

A WTRU may select an SSB from an SSB burst. In some embodiments, the WTRU may select the best SSB (e.g., with highest measured signal quality or RSRP) from an SSB burst, where the WTRU may determine, be configured with, and/or indicated to send one or more PRACH preambles on one or more configured ROs that are associated with the selected SSB. For example, the WTRU may be in RRC-Idle, RRC-Inactive, and/or RRC-Connected States. In an example, the WTRU may determine to transmit PRACH preambles during initial access, due to one or more beam recovery procedures, due to a PDCCH order, etc.

The WTRU may receive one or more configuration information and/or indications on the RO configurations to be used for PRACH transmission. The WTRU may receive the configuration and/or otherwise be indicated with the configuration, for example from a Node-B, for example via SIB, RRC, MAC-CE, DCI, etc. The configuration may include one or more threshold values and indications, in addition to one or more of a time window delta value, criteria for RO selection, RACH association periods for SBFD ROs, and/or coverage states.

For example, a WTRU may receive, be configured with, and/or indicated with one or more delta time value, time-offset, and/or time-window values, etc. In an example, the configured and/or indicated time values may be based on time units (e.g., micro-sec, msec, etc.) In another example, the time values may be based on number of symbols, slots, frames, etc.

In an example, a WTRU may receive, be configured with, and/or indicated to consider a configured and/or indicated time instance as the starting point of the configured time window. For example, the starting point may be indicated based on time units (e.g., msec, micro-sec, etc.) and/or one or more number of slots, symbols, frames, etc. with regard to, for example, frame 0. In another example, a WTRU may determine, be configured with and/or indicated to consider the start time instance for the configured time window, as the time that the WTRU is to transmit and/or retransmit a PRACH preamble. The WTRU may be configured with one or more time gaps and/or time offsets, from the time of indication or determination, within which to transmit a PRACH preamble based on a selected SSB. For example, in case of absence of indications on the starting time, the WTRU may use the time of indication or determination to transmit a PRACH preamble as the starting time of the configured time window.

A WTRU may receive, be configured with, and/or indicated with one or more configuration information and/or indications of one or more criteria for selecting the RO types. For example, the WTRU may receive an indication as to whether the criteria for RO selection is priority-based, latency-based, coverage-based, or random. The WTRU may receive one or more configuration information and/or indications regarding the indicated criteria. One or more of the following may apply. If the RO selection is configured to be priority-based, the WTRU may receive indications on which RO type has a higher or lower priority. For example, the WTRU may be configured to consider a Type 1 RO with higher priority for a configured and/or indicated time window, starting from a determined, configured, and/or indicated time instance. If RO selection is configured to be latency-based, the WTRU may receive indications on one or more thresholds on time gaps, time offsets, time durations, etc. If RO selection is configured to be coverage-based, the WTRU may receive indications of one or more thresholds for RRM measurements and/or one or more quality parameters. For example, the quality parameters may be RSRP, RSRQ, SINR, SNR, etc. If RO selection is configured to be performed randomly, the WTRU may receive one or more configuration information on one or more weighting values. For example, the WTRU may receive one or more weighting values, for example via SIB, RRC, MAC-CE, DCI, etc. In an example, the WTRU may be indicated to activate one of the weighting values from the configured or pre-configured weighting values. For example, the WTRU may receive the activation indication, for example, via MAC-CE, DCI, etc. In an example, the WTRU may receive a first weighting value to be used for randomly selection of ROs out of SBFD and non-SBFD ROs.

In an example, a WTRU may receive an indication (e.g., a flag indication) as to whether the RACH association period for Type 2 ROs (e.g., SBFD ROs) is the same as, or different from, the RACH association period for Type 1 ROs (e.g., non-SBFD ROs). The WTRU may determine the RACH association period for Type 1 ROs. For example, if the indication has a first value (e.g., value zero), the WTRU may determine that the determined RACH association period for Type 1 ROs should also be used for Type 2 ROs. For another example, if the indication indicates a second value (e.g., value one), the WTRU may determine that the determined RACH association period for Type 1 ROs is different from the RACH association period for Type 2 ROs.

A WTRU may determine, be configured, and/or indicated to use the same configuration table (e.g., TABLE 1) for determining the RACH association period for Type 2 ROs if the WTRU is indicated that the RACH association period for the Type 2 ROs is different from the RACH association period for the Type 1 ROs. In some embodiments, the WTRU may determine, be configured, and/or indicated to use a different configuration table for determining the RACH association period for Type 2 ROs if the WTRU is indicated that the RACH association period for the Type 2 ROs is different from the RACH association period for the Type 2 ROs.

A WTRU may receive, be configured with, and/or indicated with one or more configuration information and/or indications, based on which the WTRU may determine the WTRU's coverage state. In some embodiments, the WTRU may be configured with one or more configurations for measuring one or more quality parameters in addition to one or more corresponding thresholds. In another example, the WTRU may be configured with one or more coverage states that can be, for example, a low coverage state, a moderate coverage state, and/or a strong coverage state.

A WTRU may measure one or more quality parameters, for example RSRP, RSSI, SNR, SINR, etc., for example based on one or more RSs (e.g., SSB, CSI-RS, etc.). The WTRU may determine if the WTRU is in a low coverage state, a moderate coverage state, and/or a strong coverage state based on the measured quality parameters and the configured thresholds. For example, if the measured quality parameter is higher than a first corresponding configured threshold, the WTRU may determine that the WTRU is in a strong coverage state. If the measured quality parameter is lower than the first threshold and higher than a second threshold, the WTRU may determine that the WTRU is in a moderate coverage state. If the measured quality parameter is lower than the second threshold, the WTRU may determine that the WTRU is in a low coverage state. The configured first and second thresholds may have different values or the same value.

A WTRU may determine the PRACH UL power for PRACH transmission. The WTRU may determine if the WTRU is in a low coverage state, a moderate coverage state, and/or a strong coverage state based on the determined PRACH UL power and one or more configured corresponding threshold. For example, if the determined PRACH UL power is higher than a first threshold, the WTRU may determine that the WTRU is in a low coverage state. If the determined PRACH UL power is lower than the first threshold and higher than a second threshold, the WTRU may determine that the WTRU is in a moderate coverage state. If the determined PRACH UL power is lower than the second threshold, the WTRU may determine that the WTRU is in a strong coverage state. The configured first and second thresholds may have different or similar values.

Returning to FIG. 5, a WTRU may identify the closest RO of a first type to a current frame (504) and may identify the closest RO of a second type to the current frame (506). For example, a WTRU may identify, find, and/or determine the nearest RO that is associated with the selected SSB, from the set of Type 1 ROs and/or Type 2 ROs. The WTRU may determine a nearest first RO from the set of Type 1 ROs and a nearest second RO from the set of Type 2 ROs. As such, the WTRU may determine and/or calculate a first time distance from the WTRU's current time to the determined first RO, and the WTRU may determine and/or calculate a second time distance from the WTRU's current time to the determined second RO. The WTRU may calculate the time difference between the calculated first time distance and the second time distance. The WTRU may determine, be configured, and/or indicated to calculate the time difference based on time units (e.g., msec, micro-sec, etc.) and/or based on the number of slots, symbols, frames, etc.

A WTRU may select either the closest RO of the first type or the closest RO of the second type based on one or more selection criteria (508).

In some embodiments, a WTRU may select an RO for PRACH transmission associated with a selected SSB based on one or more conditions, criteria, and so forth. The WTRU may be configured with one or more threshold, time window, starting time, RO selection criteria, and so forth, as described herein. One or more of the following may apply: coverage-based RO selection, latency-based RO selection, priority based RO selection and/or random selection.

When coverage-based RO selection is configured, a WTRU may determine, be configured, and/or indicated to perform RO selection based on the WTRU's determined coverage state. For example, the WTRU may determine, be configured, and/or indicated that the RO selection may be coverage-based. In an example, the WTRU may determine, be configured, and/or indicated to prioritize or deprioritize Type 1 ROs in RO selection for PRACH transmission for a configured time window, based the WTRU's coverage state.

A WTRU that is determined to be in a low coverage state may determine, be configured, and/or indicated to select from the set of Type 1 (e.g., legacy) ROs for PRACH transmission if the nearest Type 1 RO is close enough. As such, if the WTRU has identified a Type 1 RO to be the nearest RO in time to the time of RO selection, the WTRU may select the identified Type 1 RO for PRACH transmission. In another scenario, the WTRU may identify a Type 2 RO to be the nearest RO in time to the time of RO selection. The WTRU may determine that the nearest Type 1 RO may be farther in time compared to the identified Type 2 RO. In this scenario, the WTRU may select the identified Type 2 (e.g., SBFD) RO only if the time difference between the nearest Type 1 RO and the nearest Type 2 RO is higher than a determined, configured, and/or indicated time duration value. Otherwise, if the time difference between the nearest Type 1 RO and the nearest Type 2 RO is shorter than the configured time duration value, the WTRU may select the identified Type 1 RO for PRACH preamble transmission. In other words, the WTRU may determine, be indicated, and/or be configured to deprioritize Type 2 (e.g., SBFD) ROs if the WTRU is in a low coverage state unless the nearest Type 1 RO is much farther in time than the nearest Type 2 RO. A benefit for such configurations is that WTRUs in low coverage can use legacy ROs with potentially higher maximum UL power limitations (e.g., Pcmax) for PRACH preamble transmission.

A WTRU that is determined to be in a moderate coverage state may determine, be configured, and/or indicated to select from the set of Type 2 (e.g., SBFD) ROs for PRACH transmission if the nearest Type 2 RO is close enough. As such, if the WTRU has identified a Type 2 RO to be the nearest RO in time to the time of RO selection, the WTRU may select the identified Type 2 RO for PRACH transmission. In another scenario, the WTRU may identify a Type 1 RO to be the nearest RO in time to the time of RO selection. The WTRU may determine that the nearest Type 2 RO may be farther in time compared to the identified Type 1 RO. In this scenario, the WTRU may select the identified Type 1 (e.g., legacy) RO only if the time difference between the nearest Type 2 RO and the nearest Type 1 RO is higher than a determined, configured, and/or indicated first time duration value. Otherwise, if the time difference between the nearest Type 2 RO and the nearest Type 1 RO is shorter that the configured time duration value, the WTRU may select the identified Type 2 RO for PRACH preamble transmission. In other words, the WTRU may determine, be indicated, and/or be configured to deprioritize Type 1 (e.g., legacy) ROs if the WTRU is in a moderate coverage state unless the nearest Type 2 RO is much farther in time than the nearest Type 1 RO. A benefit for such configurations may be preventing WTRUs in moderate coverage from using legacy ROs only for the convenience of having higher power, which may result in higher contention and overloading legacy ROs.

A WTRU that is determined to be in a strong coverage state may determine, be indicated, and/or be configured to deprioritize Type 1 (e.g., legacy) ROs. As such, the WTRU may use Type 1 ROs only if the nearest Type 2 RO is much farther in time, based on a determined, configured, and/or indicated second time window. For example, the configured second time window may be longer than the configured first time window that may be used if the WTRU is in a moderate coverage state. A benefit for such configurations may be to get the WTRUs with strong coverage to use SBFD ROs, leaving legacy ROs for legacy WTRUs, low-end WTRUs, and/or low-coverage WTRUs.

When latency-based RO selection is used, for example, a WTRU may determine, be configured, and/or indicated that the RO selection may be latency-based. In an example scenario, the network (NW) may prefer the SBFD-enabled WTRUs to select and use legacy ROs for PRACH preamble transmission in a cell that has mostly SBFD ROs with the legacy ROs being largely left unused. In such a scenario, a WTRU may determine that a nearest Type 2 RO associated with a selected SSB is closer in time than a nearest Type 1 RO associated with a selected SSB. The WTRU may calculate the difference between the time duration until the nearest Type 1 RO (e.g., legacy RO) and the time duration until the nearest Type 2 RO (e.g., SBFD RO). The WTRU may determine, be configured, and/or indicated to select the Type 1 RO if the time difference between the two ROs is lower than a determined, configured, and/or indicated time duration and/or time delta value. That is, the WTRU may select the nearest Type 1 RO, although it is farther than the nearest Type 2 RO in time, if the nearest Type 1 RO is close enough, for example based on the configured time delta value. Otherwise, if the nearest Type 1 RO is farther than the nearest Type 2 RO in time, and if the time difference is higher than the configured time delta value, the WTRU may use the Type 2 RO for PRACH preamble transmission.

When priority-based RO selection is used, a WTRU may determine, be configured, and/or indicated that the RO selection may be priority-based. The WTRU may also determine, be configured, and/or indicated with the priority type, the starting time, the time window, etc. during which the WTRU may apply the determined, configured, and/or indicated priority for RO selection. In an example, the WTRU may receive one or more indications of the priority type to be applied from the starting time and during the time window. For example, the WTRU may determine, be configured, and/or indicated to deprioritize Type 1 ROs, to deprioritize Type 2 ROs, to prioritize Type 1 ROs, to prioritize Type 2 ROs, and so forth. If a WTRU is configured to deprioritize Type 1 ROs (e.g., legacy ROs), or if a WTRU is configured to prioritize Type 2 ROs, the WTRU may select the nearest Type 2 (e.g., SBFD) RO for PRACH preamble transmission that is associated with the selected SSB, even if a Type 1 (e.g., legacy) RO is nearer in time to the WTRU's time instance at the time of RO determination and/or RO selection. If ta WTRU is configured to deprioritize Type 2 ROs (e.g., SBFD ROs), or if a WTRU is configured to prioritize Type 1 ROs, the WTRU may select the nearest Type 1 (e.g., legacy) RO for PRACH preamble transmission that is associated with the selected SSB, even if a Type 2 (e.g., SBFD) RO is nearer in time to the WTRU's time instance at the time of RO determination and/or RO selection.

When random RO selection is used, a WTRU may determine, be configured, and/or indicated that the RO selection may be performed randomly. The WTRU may also determine, be configured, and/or indicated with the starting time, the time window, etc. during which the WTRU may perform the RO selection based on random selection. For example, the WTRU may receive one or more configuration information and/or indications of one or more weight values. For example, the WTRU may be configured or pre-configured (e.g., via RRC, MAC-CE, DCI, etc.) with one or more weight values, based on which the WTRU may receive an indication (e.g., via MAC-CE, DCI, etc.) to activate at least one of the configured or pre-configured weight values. For example, the WTRU may receive an indication of the weight value to be used for performing the random selection. The WTRU may use a method and/or a function to determine the selection, for example out of two options (e.g., SBFD and non-SBFD ROs), using the configured and/or indicated weights.

Returning again to FIG. 5, a WTRU may send the random access preamble in the selected RO (510).

In some embodiments, a WTRU may determine and/or calculate a second set of threshold values for the RO selection procedure based on the configured first set of threshold values and/or one or more conditions. The determined and/or calculated second set of threshold values may be determined and/or calculated, for example, based on WTRU priority type and/or based on number of PRACH transmissions. When WTRU priority type is used, a WTRU may use a first delta-value, time-window, and/or threshold value if the WTRU is of a first priority type, and the WTRU may use a second delta-value, time-window, and/or threshold value if the WTRU is of a second priority type. For example, a WTRU with high priority may use a shorter delta-value and/or time-window, and a WTRU with low or moderate priority may determine, be configured, and/or indicated to use shorter delta-time values, shorter time windows, etc. if the number of trials for PRACH transmission and/or number of PRACH preamble retransmissions exceeds a determined, configured, and/or indicated maximum value.

A WTRU may use a first delta-value, time-window, and/or time threshold if the number of PRACH retransmissions and/or the number of PRACH preamble transmission trials and/or repetitions is less than a corresponding configured threshold. The WTRU may use a second delta-value, time-window, and/or time threshold if the number of PRACH retransmissions, trials, and/or repetitions is greater than the corresponding threshold. For example, the first time window may be longer than the second time window.

A WTRU may use a set of lower-bound first thresholds on one or more quality parameters for determining the WTRU's moderate coverage state. That is, if a measured quality parameter is higher than the corresponding lower-bound first threshold, the WTRU may determine to be in a moderate coverage state, and if the measured quality parameter is lower than the corresponding lower-bound first threshold, the WTRU may determine to be in a low coverage state. For example, the WTRU may use the first set of lower-bound thresholds if the number of PRACH preamble transmission trials and/or repetitions is less than a corresponding configured threshold. For another example, if the number of PRACH preamble retransmission, trials, and/or repetition is greater than the corresponding threshold, the WTRU may use a second set of lower-bound thresholds for determining the moderate and low coverage states. For example, the second set of lower-bound thresholds may be higher than the first set of configured lower-bound thresholds. As such, a WTRU in a moderate coverage state (e.g., based on first set of configured thresholds) that has experienced multiple retransmissions and/or retrials may fall back to a low coverage state (e.g., based on the second set of determined thresholds). Thus, the fallback may allow the WTRU to use Type 1 ROs with higher PRACH UL power.

A WTRU may receive a configuration or indication of one or more functions, based on one or more configurable control parameters, for a selective RO determination mechanism (e.g., including a corresponding RACH association period and/or RACH association pattern period, which may be based on an RO-type (e.g., the Type 1 RO(s) or the Type-2 RO(s))), where the one or more configurable control parameter may be based on at least one of following: one or more time-domain-related control parameters, one or more explicit RO-type control parameters, one or more measured RSs parameter, one or more power-domain parameters, and/or one or more frequency-domain parameters.

The one or more time-domain-related control parameters may control the WTRU behavior on timing of selecting an RO-type and/or an RO of the selected RO-type in relation to the selected SSB. A WTRU may use the one or more explicit RO-type control parameters to determine the one or more functions for selecting an RO-type and/or an RO of the selected RO-type.

The one or more measured RSs parameter may be, for example, SSB, CSI-RS, CSI-RS for tracking (e.g., tracking RS (TRS)), CSI-RS for beam management, etc.) and/or corresponding measurement metrics (e.g., RSRP, Layer-1(L1-)RSRP, RSSI, L1-RSSI, SNR, SINR, L1-SINR, etc.), based on which the WTRU may determine the one or more functions for selecting an RO-type and/or an RO of the selected RO-type. Such explicitly configured or implicitly determined one or more measured RSs and/or corresponding measurement metrics may be used (e.g., applied) for the WTRU to determine the one or more functions.

The one or more power-domain parameter may be based on UL power control parameters (e.g., at least one of {P0, P_offset, alpha, a pathloss (PL)-RS, a closed-loop (CL)-index}. A WTRU may, for example, determine a UL transmit power level (P) (e.g., on a given time i, P(i)=P0+P_offset (i)+alpha*PL(i) (estimated by the PL-RS)+a value of a transmit PC (TPC) accumulator (or an absolute TPC value) associated with the CL-index). The determined UL transmit power level (P) may be used for a UL transmission (e.g., PUSCH, PUCCH, and/or SRS), where the one or more power-domain parameters may further be based on the determined UL transmit power level (P) and/or a determined PRACH UL power (e.g., in a form of a ratio or scaling parameter).

The one or more frequency-domain parameters may be based on a frequency distance parameter between an RO and an RB within an SBFD subband (e.g., UL subband, DL subband, guard band, flexible subband where an actual subband link direction may be determined dynamically and/or flexibly based on one or more conditions).

The embodiments described herein may be applied for selecting of one or more (e.g., UL) occasions out of a subset of different types of occasions that are determined in association with SSB mapping. Such embodiments may be used for determining SSB-to-RO mapping for PRACH preamble (e.g., Msg1) transmission. Such embodiments may also be used for determining PUSCH Occasions (POs) in SSB-to-PO mapping for random access PUSCH (e.g., Msg A) transmission. Such embodiments may also be used for determining PUSCH occasions for mapping a number of valid PUSCH occasions for PUSCH transmissions over an association period, for example for configured grant Type 1 PUSCH transmissions on the initial UL BWP (e.g., for Small Data Transmission (SDT)). Additionally, while for the brevity of discussion, resource selection is described herein in terms of RO selection, the embodiments described herein may equally, equivalently, or extendedly, be employed (e.g., applicable) in cases with other resource selection types (e.g., PO, SDT, etc.).

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed:

1. A method, implemented in a wireless transmit/receive unit (WTRU) configured with a plurality of random access occasions (ROs), wherein each of the plurality of ROs is one of a first type of RO or a second type of RO, the method comprising:
selecting a synchronization signal block (SSB) from a plurality of SSBs for a random access preamble transmission, wherein each of the plurality of SSBs is mapped to a subset of the plurality of ROs;
identifying a closest RO of the first type to a current frame;
identifying a closest RO of the second type to the current frame;
selecting either the closest RO of the first type or the closest RO of the second type based on one or more RO selection criteria; and
sending the random access preamble in the selected RO.

2. The method of claim 1, wherein the selecting the SSB comprises:
measuring a signal quality of each of the plurality of SSBs, and
selecting one of the plurality of SSBs that has the highest signal quality measurement.

3. The method of claim 1, wherein the one or more RO selection criteria comprises at least one of a coverage of the WTRU, latency, or random selection.

4. The method of claim 1, wherein the first type of RO is a subband non-overlapping full duplex (SBFD) RO and the second type of RO is a non-SBFD RO.

5. The method of claim 1, wherein the one or more RO selection criteria comprises coverage of the WTRU, and the selecting either the closest RO of the first type or the closest RO of the second type based on the one or more RO selection criteria further comprises selecting the closest RO of the second type on a condition that the WTRU is in a low coverage state unless the closest RO of the second type is a first time duration value farther than the closest RO of the first type.

6. The method of claim 5, wherein the selecting either the closet RO of the first type or the closest RO of the second type based on the one or more RO selection criteria further comprises selecting the closest RO of the first type on a condition that either:
the WTRU is in a moderate coverage state unless the closest RO of the first type is a second time duration value farther than the closest RO of the second type, or
the WTRU is in a strong coverage state unless the closest RO of the first type is a third time duration value farther than the closest RO of the second type, wherein the third time duration value is longer than the second time duration value.

7. The method of claim 6, further comprising:
determining that the WTRU is in the low coverage state on a condition that a measured signal quality of the selected SSB is less than a first threshold,
determining that the WTRU is in the moderate coverage state on a condition that the measured signal quality of the selected SSB is greater than or equal to the first threshold and less than a second threshold, and
determining that the WTRU is in the strong coverage state on a condition that the measured signal quality of the selected SSB is greater than or equal to the second threshold.

8. The method of claim 6, wherein a first set of values for the first, second and third time duration values is configured by a base station.

9. The method of claim 8, further comprising determining a second set of values for the first, second and third time duration values, based on the first set of values, on a condition that a number of random access preamble transmission retransmission is less than a maximum number.

10. The method of claim 9, wherein the second set of values comprises shorter time durations on the condition that the number of the random access preamble retransmission is more than the maximum number.

11. A wireless transmit/receive unit (WTRU) configured with a plurality of random access occasions (ROs), wherein each of the plurality of ROs is one of a first type of RO or a second type of RO, the WTRU comprising:
a transceiver; and
a processor,
wherein the transceiver and the processor are configured to select a synchronization signal block (SSB) from a plurality of SSBs for a random access preamble transmission, wherein each of the plurality of SSBs is mapped to a subset of the plurality of ROs,
wherein the transceiver and the processor are further configured to identify a closest RO of the first type to a current frame,
wherein the transceiver and the processor are further configured to identify a closest RO of the second type to the current frame,
wherein the transceiver and the processor are further configured to select either the closest RO of the first type or the closest RO of the second type based on one or more RO selection criteria, and
wherein the transceiver and the processor are further configured to send the random access preamble in the selected RO.

12. The WTRU of claim 11, wherein the processor and the transceiver are further configured to select the SSB by:
measuring a signal quality of each of the plurality of SSBs, and
selecting one of the plurality of SSBs that has the highest signal quality measurement.

13. The WTRU of claim 11, wherein the one or more RO selection criteria comprises at least one of a coverage of the WTRU, latency, or random selection.

14. The WTRU of claim 11, wherein the first type of RO is a subband non-overlapping full duplex (SBFD) RO and the second type of RO is a non-SBFD RO.

15. The WTRU of claim 11, wherein the one or more RO selection criteria comprises coverage of the WTRU, and the processor and the transceiver are further configured to select either the closest RO of the first type or the closest RO of the second type based on the one or more RO selection criteria by selecting the closest RO of the second type on a condition that the WTRU is in a low coverage state unless the closest RO of the second type is a first time duration value farther than the closest RO of the first type.

16. The WTRU of claim 15, wherein the processor and the transceiver are further configured to select either the closet RO of the first type or the closest RO of the second type based on the one or more RO selection criteria by selecting the closest RO of the first type on a condition that either:
the WTRU is in a moderate coverage state unless the closest RO of the first type is a second time duration value farther than the closest RO of the second type, or
the WTRU is in a strong coverage state unless the closest RO of the first type is a third time duration value farther than the closest RO of the second type, wherein the third time duration value is longer than the second time duration value.

17. The WTRU of claim 16, wherein the transceiver and the processor are further configured to:
determine that the WTRU is in the low coverage state on a condition that a measured signal quality of the selected SSB is less than a first threshold,
determine that the WTRU is in the moderate coverage state on a condition that the measured signal quality of the selected SSB is greater than or equal to the first threshold and less than a second threshold, and
determine that the WTRU is in the strong coverage state on a condition that the measured signal quality of the selected SSB is greater than or equal to the second threshold.

18. The WTRU of claim 16, wherein a first set of values for the first, second and third time duration values is configured by a base station.

19. The WTRU of claim 18, wherein the processor and the transceiver are further configured to determine a second set of values for the first, second and third time duration values, based on the first set of values, on a condition that a number of random access preamble transmission retransmission is less than a maximum number.

20. The WTRU of claim 19, wherein the second set of values comprises shorter time durations on the condition that the number of the random access preamble retransmission is more than the maximum number.
